(19) United States
(12) Patent Application Publication
(10) Pub. No.: US 2026/0281416 A1
(43) Pub. Date: Sep. 17, 2026

(54) PREDICTION FOR SMALL BLOCK PARTITION UNDER MIXED INTRA AND INTER REGIONS

(71) Applicant: Tencent America LLC, Palo Alto, CA (US)

(72) Inventors: Jayasingam ADHURAN, Palo Alto, CA (US); Liang ZHAO, Palo Alto, CA (US); Madhu PERINGASSERY KRISHNAN, Palo Alto, CA (US); Shan LIU, Palo Alto, CA (US)

(21) Appl. No.: 19/367,788

(22) Filed: Oct. 23, 2025

Related U.S. Application Data
(60) Provisional application No. 63/770,275, filed on Mar. 11, 2025.

(51) Int. Cl. H04N 19/51; H04N 19/137; H04N 19/186

(52) U.S. Cl. CPC H04N 19/51; H04N 19/137; H04N 19/186

(57) ABSTRACT

An example method of video coding includes receiving a video bitstream including a plurality of blocks, including a current region of blocks comprising one or more chroma blocks. The method includes, when the current region is a first type of region, assigning a same prediction mode to the one or more chroma blocks; and reconstructing each chroma block of the one or more chroma blocks by applying the prediction mode at a sub-block level.

### RELATED APPLICATIONS

This application claims priority to U.S. Provisional Patent Application No. 63/770,275, entitled “Prediction for Small Block Partition Under Mixed Intra and Inter Regions,” filed March 11, 2025, which is hereby incorporated by reference in its entirety.

### TECHNICAL FIELD

The disclosed embodiments relate generally to video coding, including but not limited to systems and methods for block partitioning, intra prediction and mode signaling.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On January 8, 2019, a validated version 1.0.0 with Errata 1 of the specification was released.

### SUMMARY

The present disclosure describes amongst other things, a set of methods for video (image) compression, more specifically related to block partitioning. By performing motion compensation at a sub-block level for chroma blocks in a chroma merge region, delays associated with processing all luma blocks within a co-located region may be removed. For example, if a co-located region has four luma blocks, and motion compensation were performed at the whole block level, all four luma blocks have to be processed (e.g., including a last luma block) to provide chroma information for motion compensation. By performing motion compensation at a sub-block level for chroma block, faster processing may be achieved.

In accordance with some embodiments, a method of video decoding includes (i) receiving a video bitstream comprising a plurality of blocks, including a current region of blocks comprising one or more chroma blocks; (ii) when the current region is a first type of region, assigning a same prediction mode to the one or more chroma blocks; and (iii) reconstructing each chroma block of the one or more chroma blocks by applying the prediction mode at a sub-block level.

In accordance with some embodiments, a method of video encoding includes (i) receiving video data comprising a plurality of blocks, including a current region of blocks comprising one or more chroma blocks; (ii) when the current region is a first type of region, assigning a same prediction mode to the one or more chroma blocks; and (iii) encoding each chroma block of the one or more chroma blocks by applying the prediction mode at a sub-block level.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A, 4B, and 4C illustrate examples of partitioning of coding blocks in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including block partitioning. By performing motion compensation at a sub-block level for chroma blocks in a chroma merge region, delays associated with processing all luma blocks within a co-located region may be removed. For example, if a co-located region has four luma blocks, and motion compensation were performed at the whole block level, all four luma blocks have to be processed (e.g., including a last luma block) to provide chroma information for motion compensation. By performing motion compensation at a sub-block level for chroma block, faster processing may be achieved.

Various techniques and systems are disclosed for improving video coding efficiency and reducing hardware requirements by modifying the handling of small block partitions, particularly in mixed intra and inter regions and chroma merge regions. For example, when any chroma block under a parent partition node has a width or height smaller than a predefined threshold (such as 4 samples), all luma blocks within the corresponding chroma merge region are forced to use the same prediction mode (e.g., an inter prediction). This eliminates the need to wait for the last luma block’s information to determine the chroma block’s prediction mode, thereby removing parsing dependencies and reducing decoding and encoding delays. Additionally, some embodiments include disallowing 4x4 block partitioning in mixed intra and inter regions, further simplifying hardware implementation by avoiding the complexity of supporting small inter-coded blocks. These techniques and systems result in a more hardware-friendly decoding process, lower latency, and reduced implementation complexity, while maintaining coding efficiency. The approach is particularly advantageous for real-time and resource-constrained video applications, as it streamlines the prediction mode signaling and block partitioning logic, leading to faster and more predictable decoding and encoding operations.

### Example Systems and Devices

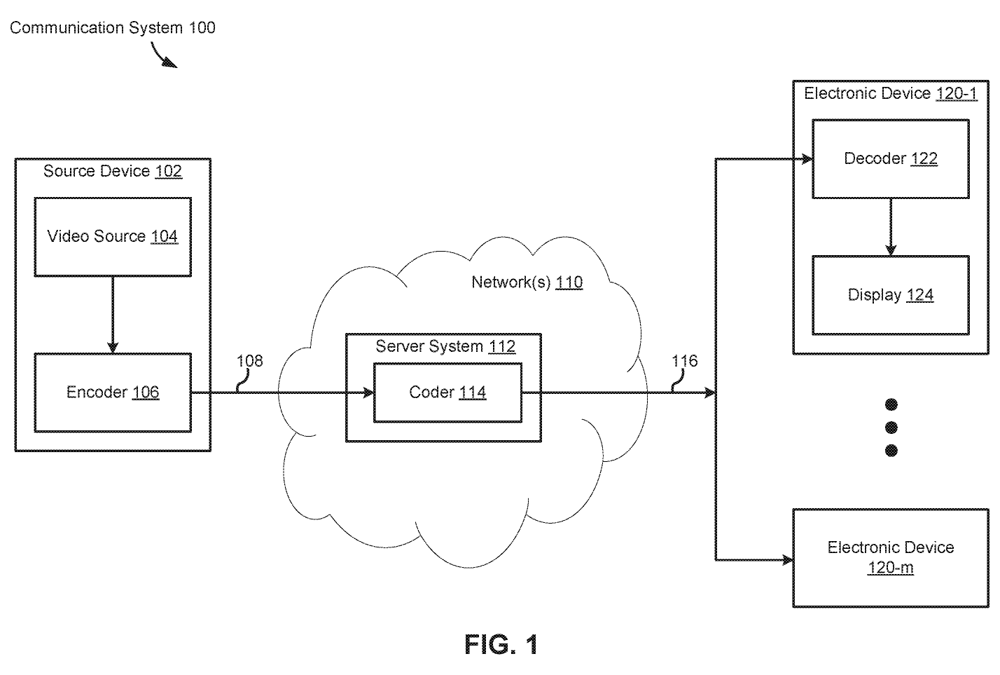

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

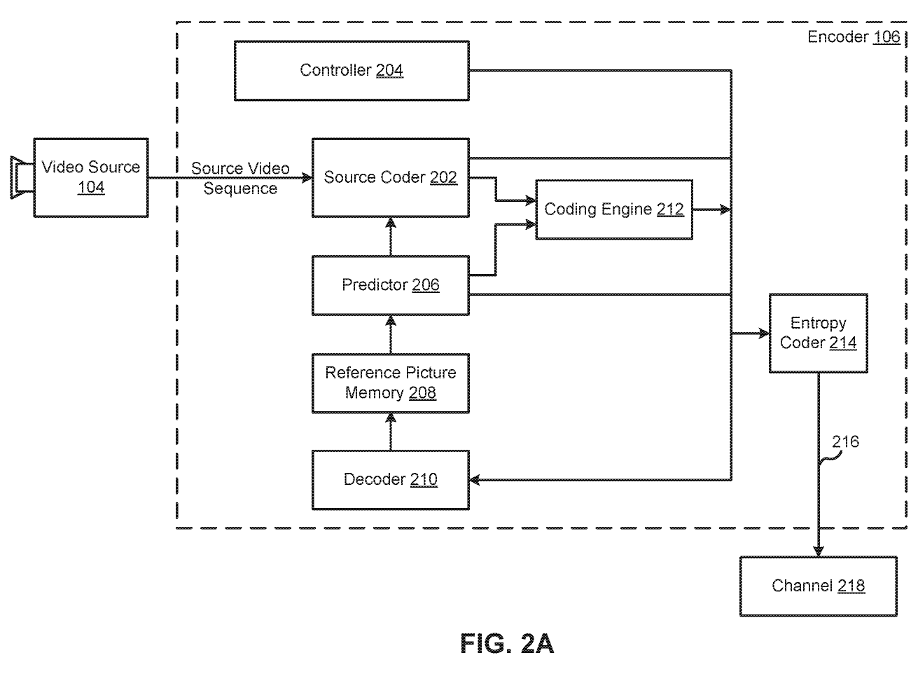

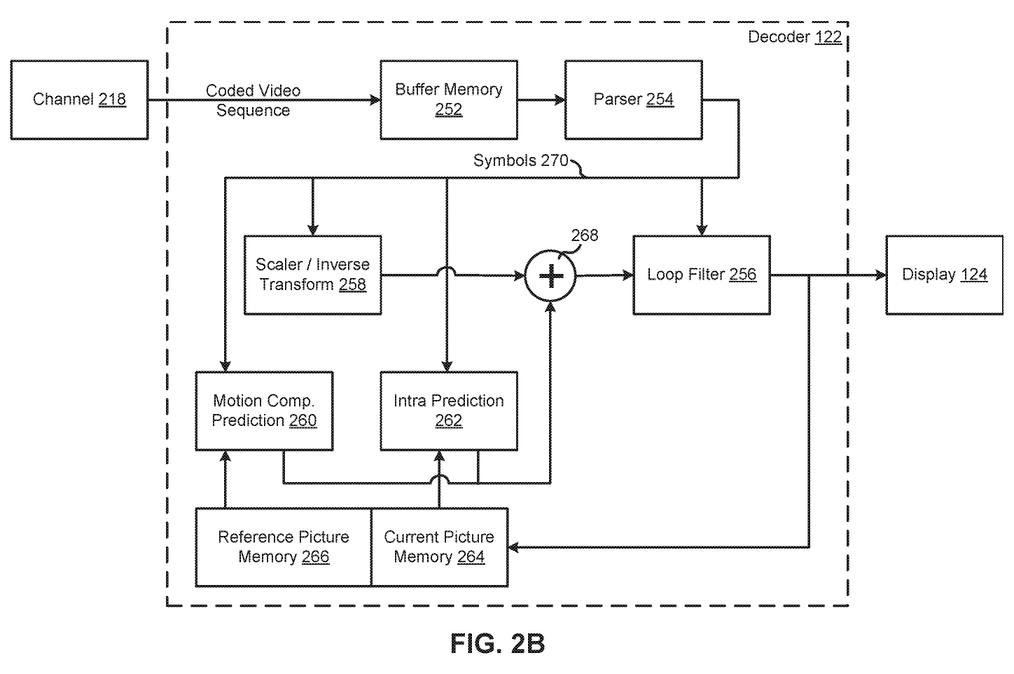

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote decoder. Thus, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter sets, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4x4, 8x8, 4x8, or 16x16 samples each) and coded on a block-by-block basis. Blocks may be coded predictively with reference to other (already coded) blocks as determined by the coding assignment applied to the blocks’ respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, e.g., be further restricted through Hypothetical Reference Decoder (HRD) specifications and metadata for HRD buffer management signaled in the coded video sequence.

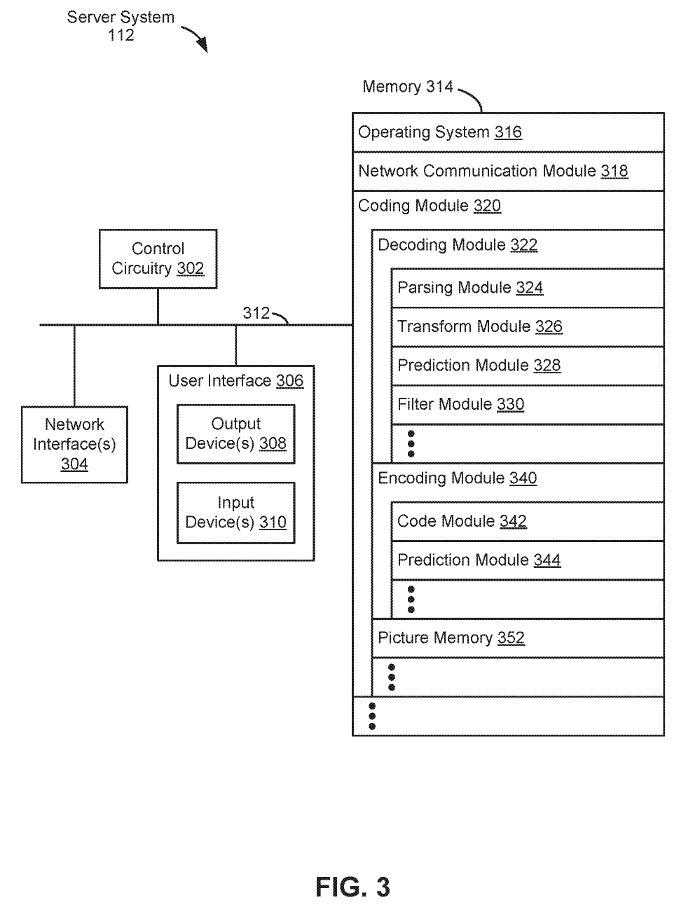

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof: an operating system 316 that includes procedures for handling various basic system services and for performing hardware-dependent tasks; a network communication module 318 that is used for connecting the server system 112 to other computing devices via the one or more network interfaces 304 (e.g., via wired and/or wireless connections); a coding module 320 for performing various functions with respect to encoding and/or decoding data, such as video data. In some embodiments, the coding module 320 is an instance of the coder component 114. The coding module 320 including, but not limited to, one or more of: a decoding module 322 for performing various functions with respect to decoding encoded data, such as those described previously with respect to the decoder component 122; and on encoding module 340 for performing various functions with respect to encoding data, such as those described previously with respect to the encoder component 106; and a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As described previously, video coding encompasses several key components, including prediction (intra and inter), transformation and quantization, entropy coding, and loop filtering, all of which work together to compress video data efficiently. The following disclosure focuses on block partitioning and motion compensation, e.g., performing sub-block motion compensation.

By performing motion compensation at a sub-block level for chroma blocks in a chroma merge region, the video coding process is able to more efficiently utilize the available prediction information from luma blocks. In conventional approaches, motion compensation for chroma blocks is typically performed at the whole block level, which requires waiting for all luma blocks within the co-located region to be processed before the chroma block can be reconstructed. This dependency introduces delays, as the chroma block reconstruction is contingent on the completion of luma block processing, particularly when the last luma block carries the necessary chroma reference information. In contrast, the present disclosure uses sub-block level motion compensation for chroma blocks within a chroma merge region. At the sub-block level, each chroma block is partitioned into smaller sub-blocks that correspond to the underlying luma blocks. Motion compensation is then performed independently for each chroma sub-block, utilizing the motion information from its associated luma block. This approach eliminates the need to wait for all luma blocks to be processed, as each chroma sub-block can be reconstructed as soon as its corresponding luma block is available.

The sub-block level motion compensation reduces coding latency by removing parsing dependencies between chroma and luma blocks. Additionally, it enables parallel processing of chroma and luma blocks, which is particularly advantageous for hardware implementations and real-time video applications. Moreover, it simplifies the block partitioning and prediction mode signaling logic, as the chroma block prediction can be determined directly from the available luma block information without additional signaling or waiting for the last luma block. The disclosed approaches yield a more hardware-friendly design, lowering implementation complexity and resource requirements while maintaining coding efficiency.

As described previously, the term “block” may refer to a coding tree block or coding block (such as a super block, a largest coding unit, a pre-defined fixed block size), a prediction block, a residual block, a transform block, or a filtering unit. Additionally, a “subblock” of a block A refers to a block whose area is fully contained in the block A. Block shape can be referred to as a block width to height ratio, block area size, whether a block is a square block, a tall block or a flat block, and the like.

As used herein, the term “block region” may refer to a block area (e.g., a specific block area) which covers at least one block, or multiple blocks. A region type of the block region may be intra region, inter region, and mixed intra and inter region. As examples, all the coded blocks in an intra region can be intra coded blocks, all the coded blocks in an inter region can be inter coded blocks or intra block copy mode, and the coded blocks can be coded in any available prediction modes in a mixed intra and inter region. If at least one of the blocks in an enclosed set is inter coded, then the region may be referred to as a mixed intra and inter region. Intra prediction modes include, for example, directional prediction modes, a DC prediction mode and a chroma from luma (CfL) mode. In an intra region, luma blocks within the intra region can be further partitioned, but chroma blocks within this block region may not be allowed to be further split.

As used herein, the phrase “an intra-inter coding mode” may refer to a coding mode that generates a prediction block using both intra and inter prediction methods. For example, an intra-inter coding mode is a prediction mode that derives the prediction block as a weighted sum of an intra prediction block and an inter prediction block.

As used herein, the phrase “an intra block copy mode” may refer to a coding method that generates a prediction block by copying a block of pixels from another part of the same frame.

As used herein, the phrase “a linear intra prediction with matched reference templates” may refer to a coding method that generates a prediction block by calculating pixel values based on a linear equation applied to pixels of a reference block located in another part of the same frame.

As used herein, the phrase “leaf partitioning tree node” may refer to a partitioning block that is not further partitioned, and prediction and residual coding are performed on the leaf partitioning tree node. As used herein, the phrase “a non-leaf partitioning tree node” may refer to a block that is further partitioned into smaller blocks, and prediction and residual coding are performed on the non-leaf partitioning tree node.

As used herein, the phrase “chroma merge” may refer to a single chroma block referencing multiple luma blocks. When there is one luma block with a width or a height equal to 4 after one block partitioning from one parent node, all the coded luma blocks and the coded chroma blocks under this parent node are considered to be in a chroma merge region. In the chroma merge region, the block width or a block height of at least one luma coded block is equal to 4. A chroma merge region may prevent intra prediction from being performed on small chroma blocks. A chroma merge region (hereinafter also sometimes referred to as chroma merge block region) may include more than one luma block but the more than one luma block may have only one co-located chroma block. The last luma block (hereinafter used to refer to a luma block in chroma merge area that carries chroma information) in the block region includes reference information of the chroma block. The prediction mode of a top left corner of a chroma block and the prediction mode of the luma block may not be the same. The top left corner of the chroma block refers to the top left corner of the luma block region whereas the top left corner of the luma block that references the chroma block refers to its own block

As used herein, the term “an inter coded block” may refer to a block that is coded using an inter prediction mode. Inter prediction modes include, for example, single prediction, compound prediction, warp prediction, combined inter-intra prediction, and intra block copy prediction.

As used herein, the term “partitioning” may refer to splitting one coding block into a single or multiple smaller blocks. As described previously, general partitioning may start from a base block (e.g., a superblock or root node) and may follow a predefined ruleset, partition structure, and/or scheme. The partitioning may be hierarchical and/or recursive. After dividing or partitioning a base block using any of the example partitioning procedures or other procedures described herein, or the combination thereof, a final set of partitions or coding blocks may be obtained. Each of these partitions may be at one of various partitioning levels in the partitioning hierarchy, and may be of various shapes. Each of the partitions may be referred to as a coding block (CB), such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The hierarchical structure of for all color channels may be collectively referred to as coding tree unit (CTU). The partitioning patterns or structures for the various color channels in a CTU may or may not be the same.

A region, or coding region, may be used to refer to any level in any one of the partitioning schemes described above or in other partitioning schemes not specifically described above. A region therefore may be a frame, a slice, a super block, a macroblock, a subblock, a prediction block, and the like. For example, a region may be any partitioning level of a recursive partitioning scheme.

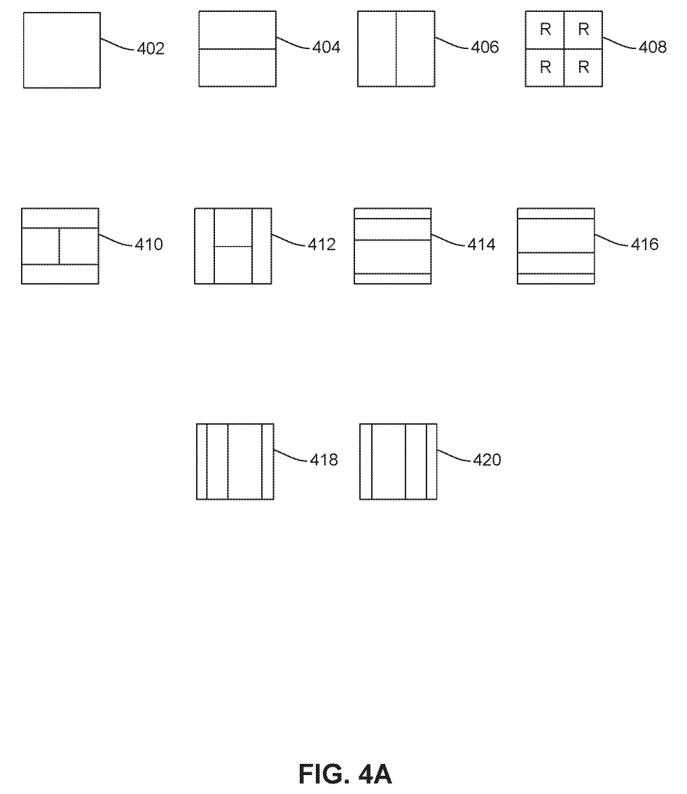

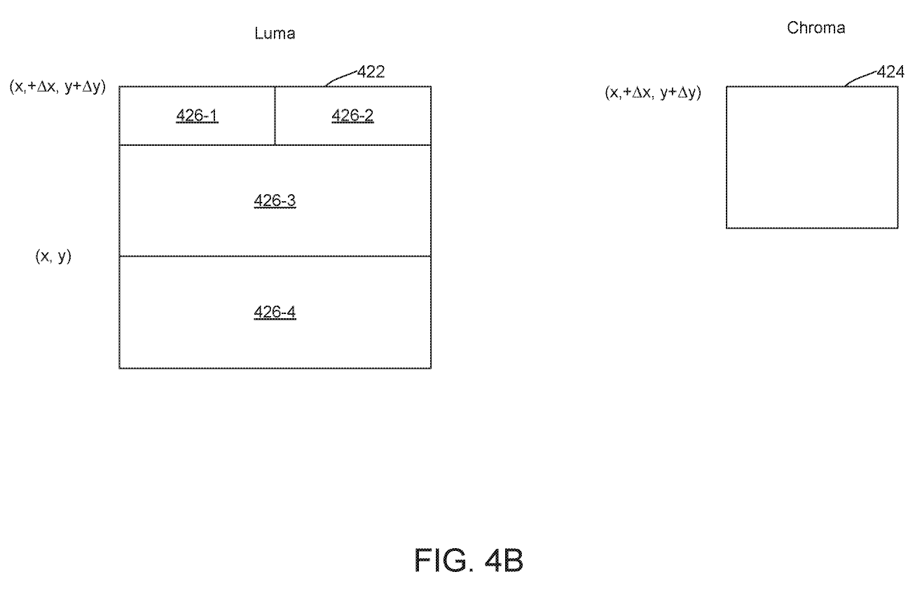

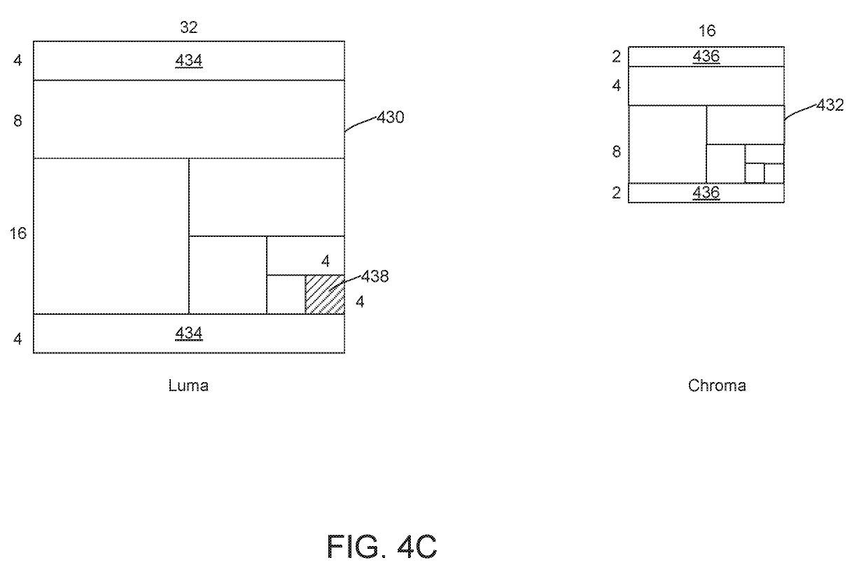

FIG. 4A shows various partition types and partitioning structures in accordance with some embodiments. The root block may start at a predefined level (e.g., from a base block at 128 x 128 or 64 x 64 level). As an example, block 402 is not further partitioned (“PARTITION_NONE”), block 404 is split into two equal horizontal partitions (“PARTITION_HORZ”), and block 406 is split into two equal vertical partitions (“PARTITION_VERT”). Block 408 is an example of a square split where a square is divided into four equal square blocks (“PARTITION_SPLIT”). Blocks 410 and 412 are H-partitions, with the block 410 being split into horizontal H partitions (“PARTITION_HORZ_3”), and the block 412 being split into vertical H partitions (“PARTITION_VERT_3”). The block 410 is horizontally split into three blocks with height ratio 1:2:1. The center block is further vertically split into two equally sized blocks. The block 412 is vertically split into three blocks with width ratio of 1:2:1. The center block is further horizontally split into two equally sized blocks.

FIG. 4A also shows partition types that include partitions from an uneven 4-way split/partitioning scheme that may be implemented horizontally, as shown in blocks 414 (“PARTITION_HORZ_4A”) and 416 (“PARTITION_HORZ_4B”), or vertically, as shown in blocks 418 (“PARTITION_VERT_4A”) and 420 (“PARTITION_HORZ_4B”). In particular, partition 414 is horizontally split into 1:2:4:1 regions. Block 416 is horizontally split into 1:4:2:1 regions. Block 418 is vertically split with 1:2:4:1 regions. Block 420 is vertically split with 1:4:2:1 regions.

As used herein, the phrase “a direction of the partition” may refer to the direction of the split of the first child. For example, the direction of PARTITION_VERT, PARTITION_VERT_3, PARTITION_VERT_4A and PARTITION_VERT_4B is vertical whereas the direction of PARTITION_HORZ, PARTITION_HORZ_3, PARTITION_HORZ_4A and PARTITION_HORZ_4B is horizontal.

In some approaches, a chroma block under a parent partition node having a width or height smaller than 4 is merged with multiple chroma blocks for prediction, to avoid having to perform 2xN or Nx2 intra prediction on a chroma block. The prediction type of the merged chroma blocks is determined by the last luma coded block within the corresponding co-located area. Whether sub-block or whole-block prediction is adopted for all chroma blocks under the parent partition node depends on whether any of the co-located luma blocks are coded as intra prediction or IntraBC prediction. This introduces a parsing dependency for chroma blocks. If the last luma block is inter coded, then the chroma block is also inter coded. The chroma block would also inherit inter coding mode information from the luma block. In some embodiments, the prediction type for chroma blocks is fixed as inter prediction when any chroma block under the parent partition has a width or height that is smaller than 4. The prediction type of the corresponding co-located luma blocks is also fixed to be inter prediction, thereby removing the parsing dependency. In some embodiments, 4x4 block partitioning is disallowed under the chroma merge region.

As illustrated in FIG. 4B, a luma parent partition node 422 have four luma blocks 426-1, 426-2, 426-3, and 426-4, and a single chroma block 424 references the four luma blocks. Only the luma block 426-4 (e.g., the last luma block) contains reference information regarding the chroma block 424, except the prediction mode information of the chroma block 424. In the systems and methods described herein, in some embodiments, the prediction type for chroma blocks is fixed as inter prediction when any chroma block under the parent partition node has a width or height smaller than 4. The prediction type of the co-located luma blocks is also fixed to inter prediction, thereby removing the parsing dependency.

As illustrated in FIG. 4C, a horizontal uneven 4-way split is applied to a 32×32 partition node 430, and results in 32×4 luma blocks 434 and 16×2 chroma blocks 436. The prediction type (e.g., prediction mode) of the chroma blocks depends on the prediction type of a last coded luma block 438 (indicated by the grey hatching the grey textured block). If the last luma coded block is inter coded, and all the luma blocks are inter coded under the parent block node, the prediction type of the chroma blocks is inferred as inter prediction, and inter prediction is performed at the sub-block level. When any chroma block under a parent partition node has a width or height smaller than 4 (e.g., chroma blocks 436), the last luma coded block (e.g., block 438) is inter coded, and all the luma blocks are inter coded under the parent partition node (e.g., partition node 430), the prediction type of the chroma blocks is inferred as inter prediction, and inter prediction is performed at the sub-block level. In other words, all the luma blocks under the parent partition node (e.g., partition node 430) are set to be inter coded, the prediction type of the chroma blocks (e.g., chroma blocks under the partition node 432) is inferred as inter prediction, and inter prediction is performed at the sub-block level.

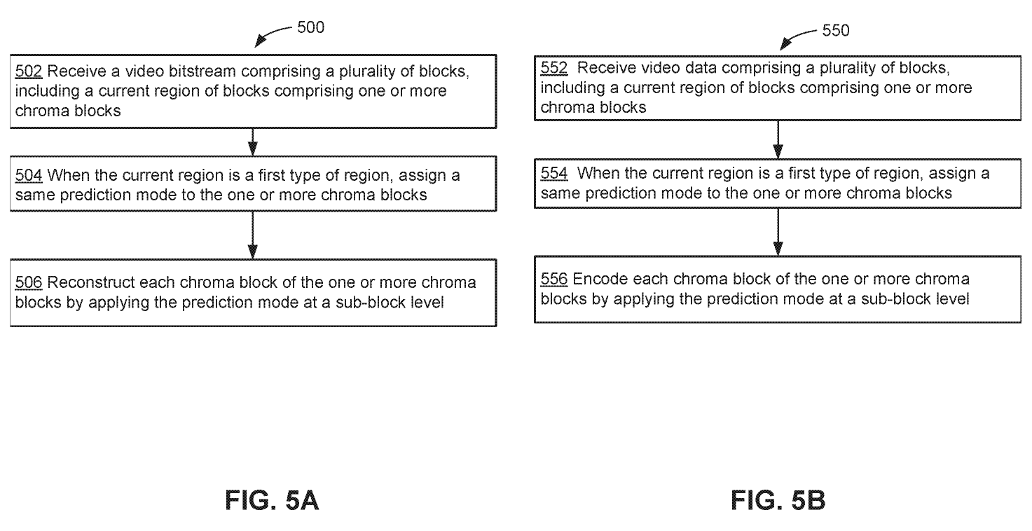

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) video bitstream (e.g., a coded video sequence) comprising a plurality of blocks (e.g., corresponding to a set of pictures), including a current region of blocks comprising one or more chroma blocks. When the current region is a first type of region, the system assigns (504) a same prediction mode to the one or more chroma blocks. The system reconstructs (506) each chroma block of the one or more chroma blocks by applying the prediction mode at a sub-block level. In this way, the supported block sizes or block partition types may depend on the region type for each coded block. In some embodiments, when the current region is a different type of region, different prediction modes are assigned to the one or more chroma blocks. In this way, the supported block sizes or block partition types may depend on the region type for each coded block. In some embodiments, the supported block sizes may be different for coded blocks in intra region and mixed intra and inter region. In some embodiments, the minimum supported block size may be different for coded blocks in intra region and mixed intra and inter region. For example, in some embodiments, a 4x4 block is supported in an intra region, but 4x4 block is not supported in a mixed intra and inter region.

In some embodiments, the allowed block partition types may be different for intra region and mixed intra and inter region with certain block sizes. In some embodiments, when one partition node is 8x4 (or 4x8) in an intra region, it may be further split to two 4x4 blocks. However, when one partition node is 8x4 (or 4x8) in a mixed intra and inter region, the block is not further split to two 4x4 blocks. In some embodiments, when one partition node is a 32x4 (or 4x32) block in an intra region, it may be further split to 4 blocks with uneven 4-way block partition. However, for a partition node that is a 32x4 (or 4x32) block in a mixed intra and inter region, uneven 4-way block partition of the block is disallowed.

In some embodiments, luma coded blocks in chroma merge area can be either intra coded block or inter coded block, but chroma blocks are always set to a predefined mode, such as inter prediction mode or intra prediction mode. In some embodiments, if the last luma coded block in a chroma merge area is inter coded block, the chroma block in this merge area is derived as intra prediction mode, and the prediction mode is derived as cross component intra prediction mode, such as chroma luma mode or multi-hypothesis cross component prediction. In some embodiments, if the last luma coded block in a chroma merge area is an intra coded block, the chroma block in this merge area is derived as intra prediction mode, the exact prediction direction for chroma block may be further signaled.

In some embodiments, if the last luma coded block in chroma merge area is inter coded block or intra coded or intra block copy coded block, the chroma block in this merge area is derived as inter prediction mode. In some embodiments, allowing chroma block to be coded using inter prediction mode may depend on the prediction mode of the luma blocks covered by the chroma merge area. For example, when at least N number of inter coded block is found in the chroma merge area, then a chroma block can be coded using inter prediction mode. In one example, N is set to 1.

In some embodiments, motion compensation is performed at the coded block level (or at a whole chroma merge area level) for chroma. In some embodiments, both the reference frame and the motion vector for the chroma block may be derived from its co-located luma block or co-located neighboring luma block. In some embodiments, luma blocks covered by the chroma merge area may be searched to find inter coded luma blocks and inherit the reference frames and the motion vector for the chroma block. In some embodiments, search is carried out in a raster scan order. In some embodiments, search is carried out for every TxT block. In one example, T is set 4. In some embodiments, the search may be terminated if a luma block covered by the chroma merge area is inter coded. In one example, the search is terminated if a luma block Ti, (i=1,2,3,..n) is found to be inter coded such that Ti < Tn where Tn is the last luma block in the chroma merge area.

In some embodiments, motion compensation is performed at a sub block level for chroma. For example, the number of sub blocks may be determined by the number luma blocks covered by the chroma merge area. In some embodiments, the motion vector for chroma block is set to zero MV if its co-located luma block is intra coded or intra block copy coded. In some embodiments, the motion vector from a chroma block is set to the motion vector of its preceding co-located inter coded luma block in decoding order in a chroma merge area.

In some embodiments, the chroma merge area is implicitly derived as an inter region, wherein all the luma and chroma blocks in this region need to be inter coded or intra block copy mode. In some embodiments, a luma block in this chroma merge area can be either inter coded or intra block copy mode, but a chroma block in this chroma merge area is always inter coded. In some embodiments, motion compensation is performed at a coded block level (or at whole chroma merge area level) for chroma. In some embodiments, a luma block in this chroma merge area may have different motion vectors to perform motion compensation (MC). But a chroma block in this chroma merge area always use the same motion vector to perform MC. In some embodiments, a chroma block in this chroma merge area uses the motion vector from a luma block with a predefined position. In one example, the predefined position can be center position, top-left position, or bottom-right position of the current chroma merge area.

In some embodiments, a chroma merge area is implicitly derived as inter region, wherein all the luma and chroma blocks in this region need to be inter coded.

In some embodiments, for a chroma merge region, the chroma block inherits the coding mode information from the luma block that carries chroma information. In some embodiments, the prediction mode of the first or last luma block in a chroma merge area may be derived from the coded information.

In some embodiments, the prediction mode of the first or last luma block may depend on the region type of the current region/coded block. In one example, if the region type is INTRA, all luma blocks are intra coded. In some embodiments, if the region type is MIXED_INTER_INTRA, a prediction mode of the first or last luma block may depend on the partition type of the luma block. In some embodiments, the prediction mode of the last luma block can be implicitly derived. In one example, if the partition type is PARTITION_VERT_4A, PARTITION_HORZ_4A, PARTITION_VERT_4B, PARTITION_HORZ_4B, the last luma is intra coded.

In some embodiments, a prediction mode of the first or last luma block may depend on a block size of the first or last luma block. In one example, if the block size of the last luma is 4 X N or N X 4 (where N = 4, 8), the last luma block is intra coded. In some embodiments, a prediction mode of the last luma block may depend on the partition type of the luma block and a block size of the last luma block. In one example, if the partition type is PARTITION_VERT_4A, PARTITION_HORZ_4A, PARTITION_VERT_4B, PARTITION_HORZ_4B and the block size of the last luma block is 4 X N or N X 4 (where N = 4, 8, 16, 32, 64), the last luma block is intra coded.

In some embodiments, the prediction mode of the first or last luma block may depend on the prediction mode of the first luma block. In one example, if the prediction mode of the first luma block is intra coded, then the last luma block is intra coded.

In some embodiments, the prediction mode of the last luma block may depend on the prediction mode of the first luma block and the block size of the first luma block. In some embodiments, if the block size of the first luma is 4 X N or N X 4 where (where N = 4, 8, 16, 32, 64), then the last luma block is predicted using the same prediction mode as the first luma block. In some embodiments, if the first luma block is inter coded, then the last luma block is inter coded. In some embodiments, if the block size of the first luma block is 4 X N or N X 4 where (where N = 4, 8, 16, 32, 64), then the last luma block is predicted using the opposite prediction mode as the first luma block. In some embodiments, if the first luma block is inter coded, then the last luma block is intra coded. In some embodiments, if the block size of the first luma block is not 4 X N or N X 4 where (where N = 4, 8, 16, 32, 64), then the last luma block is predicted using same prediction mode as the first luma block. In one example, if the first luma block is inter coded, then the last luma block is inter coded. In some embodiments, if the block size of the first luma block is not 4 X N or N X 4 where (where N = 4, 8, 16, 32, 64), then last luma block is predicted using the opposite prediction mode as the first luma block. In one example, if the first luma block is inter coded, then the last luma block is intra coded.

In some embodiments, the chroma block may inherit prediction mode information from the first luma block. In one example, the chroma block inherits prediction mode information from the first luma block. In some embodiments, the chroma block inheriting prediction mode information from the first luma block may depend on the prediction mode of last luma block. In one example, when the prediction mode of the last luma block is implicitly derived and is the same as the first luma block, then the chroma block inherits prediction mode information from the first luma block.

In some embodiments, whether chroma merge is allowed may depend on the block size of the chroma block. In some embodiments, chroma merge is allowed if the width and the height of the chroma block is less than or equal to a threshold T. In one example T is set 8. In some embodiments, whether chroma merge is allowed may depend on the partition type of the luma block. In some embodiments, chroma merge is disallowed if the partition type is PARTITION_SPLIT.

In some embodiments, for a chroma merge region, the chroma block inherits the coding mode information from the luma block that carries chroma information. In some embodiments, a prediction mode of the last luma block in chroma merge area may be derived based on the coded information.

In some embodiments, if the region type of a chroma merge region is MIXED_INTER_INTRA, a prediction mode of the first or last luma block may depend on the block size or block width and height ratio of the last luma block. In some embodiments, the prediction mode of the last luma block is derived as a predefined mode when the block width and height ratio satisfy one predefined condition. In some embodiments, the predefined mode can be intra coded mode, inter coded mode, or intra block copy mode.

In some embodiments, when the block size of the last luma block is 4XN or NX4, the last luma is derived to be a predefined mode. In one example, N is greater than or equal to 16, such as 16, 32, 64. In some embodiments, when the prediction mode of the last luma block is derived as the predefined mode, the flag for indicating whether one coded block is intra coded or inter code is not parsed in the bitstream. In some embodiments, when the block size of the last luma block is 4xN or Nx4, and it is the child node from a 4xM or Mx4 block, N < M, the last luma block is derived as the predefined mode. In one example, M is set to 16. In one example, N is se to 8. In some embodiments, the prediction mode of the last luma block in one chroma merge region is derived to be intra coded when the block size is 4x4.

In some embodiments, the chroma block within the chroma merge region is always set to a predefined mode regardless of the prediction mode of the luma coded block within the chroma merge region. In one example, the predefined mode can be a chroma from luma intra prediction mode( CfL mode). In some embodiments, the predefined mode can be an inter prediction mode. In some embodiments, if the chroma merge region is a MIXED_INTER_INTRA region, the chroma prediction mode is set as an inter prediction mode. In some embodiments, the chroma inter prediction uses buffered luma MV’s from the first inter block in the MIXED_INTER_INTRA region. In some embodiments, if the chroma merge region is an INTRA region, the chroma prediction mode is set as chroma from luma (CfL) intra prediction mode.

In some embodiments, the prediction mode of all the luma blocks within the chroma merge region is the same prediction mode. In some embodiments, the prediction mode of all the coded blocks for the chroma merge region are inter coded block. In some embodiments, the intra block copy mode is regarded as inter coded block. In some embodiments, one high level syntax is signaled into at the sequence/multi-frame/frame/slide level to indicate whether the last luma block in a chroma merge area can be derived to be a predefined mode or not. In some embodiments, the predefined mode may be signaled at the sequence level, multi-frame, frame level, or slice level.

In some embodiments, the supported block sizes or block partition types may depend on the region type for each coded block. For example, the supported block sizes may be different for coded blocks in an intra region and a mixed intra and inter region. In some embodiments, the minimum supported block size may be different for coded blocks in an intra region and a mixed intra and inter region. In one example, 4x4 block is supported in an intra region, but 4x4 block is not supported in a mixed intra and inter region.

In some embodiments, the allowed block partition types may be different for an intra region and a mixed intra and inter region with certain block sizes. In some embodiments, when one partition node is 8x4 (or 4x8) in an intra region, it may be further split to two 4x4 blocks. However, when one partition node is 8x4 (or 4x8) in a mixed intra and inter region, the block is not (e.g., cannot be) further split to two 4x4 blocks. In some embodiments, when one partition node is a 32x4 (or 4x32) block in an intra region, the block may be further split to 4 blocks with uneven 4-way block partition. However, for one partition node that is 32x4 (or 4x32) in a mixed intra and inter region, uneven 4-way block partition is disallowed.

In some embodiments, luma coded blocks in chroma merge area can be either intra coded block or inter coded block, but chroma blocks are always set to a predefined mode, such as inter prediction mode or intra prediction mode. In some embodiments, if the last luma coded block in chroma merge area is an inter coded block, the chroma block in this merge area is derived as an intra coded block and the prediction mode is derived as cross component intra prediction mode, such as chroma luma mode or multi-hypothesis cross component prediction.

In some embodiments, if the last luma coded block in chroma merge area is an intra coded block, the chroma block in this merge area is derived as an intra prediction mode, the exact prediction direction for the chroma block may be further signaled.

In some embodiments, both the reference frames and the motion vector for chroma block may be derived from its co-located luma block or co-located neighboring luma block. In some embodiments, the motion vector (MV) for a chroma block is set to zero MV if its co-located luma block is an intra coded block. In some embodiments, the MV from a chroma block is set to the MV of its preceding co-located inter coded luma block in a decoding order in the chroma merge area.

In some embodiments, the chroma merge area is implicitly derived as an inter region, where all the luma and chroma blocks in this region need to be inter coded or coded in intra block copy mode. In some embodiments, a luma block in this chroma merge area can be either inter coded or coded in intra block copy mode, but a chroma block in this chroma merge area is always an inter coded block. In some embodiments, a luma block in this chroma merge area may have different MVs to perform motion compensation (MC). But a chroma block in this chroma merge area always uses the same MV to perform MC. For example, the chroma block follows the MC of the luma block MC for each subblock.

In some embodiments, a chroma block in this chroma merge area uses the MV from a luma block with a predefined position. For example, the predefined position can be the center position, the top-left position, or the bottom-right position of a current chroma merge area. Such an approach may include using one MV for all the chroma blocks, as a result, the predefined position of the luma block is specified. In some embodiments, the chroma merge area is implicitly derived as an inter region, where all the luma and chroma blocks in the region are to be inter coded.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of blocks (e.g., corresponding to a set of pictures), including a current region of blocks comprising one or more chroma blocks. When the current region is a first type of region, the system assigns (554) a same prediction mode to the one or more chroma blocks. The system encodes (556) encoding each chroma block of the one or more chroma blocks by applying the prediction mode at a sub-block level. As described previously, the encoding process may mirror the decoding processes described herein (e.g., block partitioning and prediction mode selection). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

Simulation data on AVM v9 anchor for all-intra and random access configurations has shown that by setting all luma blocks under a parent block node to be inter coded when any chroma block under a parent partition node has a width of height that is smaller than 4 results in 1% decoding time saving and 1% encoding time saving and only 0.05% coding loss for Random Access mode; and 1% encoding time saving with only 0.06% coding loss for Low Delay mode.

(A1) In one aspect, some embodiments include a method (e.g., the method 500) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks, including a current region of blocks comprising one or more chroma blocks; (ii) when the current region is a first type of region, assigning a same prediction mode to the one or more chroma blocks; and (iii) reconstructing each chroma block of the one or more chroma blocks by applying the prediction mode at a sub-block level. In this way, the supported block sizes or block partition types may depend on the region type for each coded block. In some embodiments, when the current region is a different type of region, different prediction modes are assigned to the one or more chroma blocks.

(A2) In some embodiments of A1, applying the prediction mode at the sub-block level comprises performing motion compensation at the sub-block level. For example, motion compensation is performed at a sub-block level for chroma blocks. In some embodiments, motion compensation is performed at a coded block level (or at whole chroma merge area level) for chroma components. In some embodiments, the motion vector from chroma block is set to the motion vector of its preceding co-located inter coded luma block in decoding order in chroma merge area.

(A3) In some embodiments of A1 or A2, the first region type is a chroma merge region. For example, luma coded blocks in a chroma merge area can be either intra coded block or inter coded block, but chroma blocks are always set to a predefined mode, such as inter prediction mode or intra prediction mode. As an example, if the last luma coded block in a chroma merge area is inter coded block, the chroma block in this merge area is derived as intra prediction mode, and the prediction mode is derived as cross component intra prediction mode, such as chroma from luma mode or multi-hypothesis cross component prediction. In another example, if the last luma coded block in a chroma merge area is intra coded block, the chroma block in this merge area is derived as intra prediction mode, and the exact prediction direction for chroma block may be further signaled. As another example, if the last luma coded block in a chroma merge area is inter coded block or intra coded or intra block copy coded block, the chroma block in this merge area is derived as inter prediction mode. In some embodiments, allowing chroma blocks to be coded using inter prediction mode depends on the prediction mode of the luma blocks covered by the chroma merge area. For example, when at least N number of inter coded block are found in the chroma merge area, then chroma block can be coded using inter prediction mode. As an example, N may be set to 1, 2, etc. In some embodiments, the chroma merge area is implicitly derived as a inter region, and all the luma and chroma blocks in this region need to be one inter coded or intra block copy mode. In some embodiments, luma block in this chroma merge area can be either inter coded or intra block copy mode, but chroma block in this chroma merge area is always inter coded block. In some embodiments, the chroma merge area is implicitly derived as inter region, and all the luma and chroma blocks in this region are required to be inter coded.

(A4) In some embodiments of any of A1-A3, the first region type is a mixed inter-intra region.

(A5) In some embodiments of any of A1-A4, motion information for the one or more chroma blocks is derived from one or more co-located luma blocks. In some embodiments, the co-located luma blocks are part of the current region. In some embodiments, the reference frames and/or the motion vector for chroma block are derived from a co-located luma block or co-located neighboring luma block.

(A6) In some embodiments of A5, the motion information for the one or more chroma blocks in inherited from one or more luma blocks of the current region. For example, luma blocks covered by the chroma merge area may be searched to find inter coded luma blocks and inherit the reference frames and the motion vector for chroma block. As an example, the search may be carried out in a raster scan order. In another example, the search is carried out for every TxT blocks, e.g., with T equal to 2, 4, 8, etc. In some embodiments, the search is terminated if a luma block covered by the chroma merge area is inter coded. For example, the search is terminated if luma block Ti, (i=1,2,3,..n) is found to be inter coded such that Ti < Tn where Tn is the last luma block in the chroma merge area. In some embodiments, the motion vector for chroma block is set to zero MV if its co-located luma block is intra coded block or intra block copy coded.

(A7) In some embodiments of any of A1-A6, the method further comprises determining a number of sub-blocks for the one or more chroma blocks based on a number of luma blocks in the current region partition point corresponds to a block size of 64 samples by 64 samples. For example, the number of sub blocks may be determined by the number luma blocks covered by the chroma merger area.

(A8) In some embodiments of any of A1-A7, a first set of block sizes are permitted for the first type of region; and a second set of block sizes are permitted for the second type of region, the second set being different than the first set. For example, the supported block sizes or block partition types may depend on the region type for each coded block. As an example, the supported block sizes may be different for coded blocks in intra region and mixed intra-inter region. In some embodiments, the allowed block partition types are different for intra region and mixed intra-inter regions, e.g., with respect to with particular block sizes. For example, when a partition node is 8x4 (or 4x8) in intra region, it may be further split to two 4x4 blocks. However, when one partition node is 8x4 (or 4x8) in the mixed intra-inter region, it can’t be further split to two 4x4 blocks. As another example, when a partition node is 32x4 (or 4x32) block in intra region, it may be further split to 4 blocks with uneven 4-way block partition. However, for a partition node of 32x4 (or 4x32) in the mixed intra-inter region, uneven 4-way block partition is disallowed (restricted).

(A9) In some embodiments of A8, the first type of region has a different minimum block size than the second type of region. For example, the minimum supported block size may be different for coded blocks in intra region and mixed intra-inter region. As an example, a 4x4 block is supported in an intra region, but 4x4 block is not supported in a mixed intra-inter region.

(A10) In some embodiments of any of A1-A9, the one or more chroma blocks comprises a plurality of chroma blocks and each chroma block of the plurality of chroma blocks uses a same motion vector to perform motion compensation. For example, motion compensation may be performed at coded block level (or at whole chroma merge area level) for chroma. As an example, chroma blocks in the chroma merge area may use a motion vector from a luma block with a predefined position. For example, the predefined position can be center position, top-left position, or bottom-right position of current chroma merge area.

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current region of blocks comprising one or more chroma blocks; (ii) when the current region is a first type of region, assigning a same prediction mode to the one or more chroma blocks; and (iii) encoding each chroma block of the one or more chroma blocks by applying the prediction mode at a sub-block level. In some embodiments, the method further includes signaling the blocks of the current region in a video bitstream.

(B2) In some embodiments of B1, applying the prediction mode at the sub-block level comprises performing motion compensation at the sub-block level.

(B3) In some embodiments of B1 or B2, the first region type is a chroma merge region.

(B4) In some embodiments of any of B1- B3, the first region type is a mixed inter-intra region.

(B5) In some embodiments of any of B1-B4, motion information for the one or more chroma blocks is derived from one or more co-located luma blocks.

(B6) In some embodiments of any of B1-B5, the method further comprises determining a number of sub-blocks for the one or more chroma blocks based on a number of luma blocks in the current region.

(C1) In one aspect, some embodiments include a method of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks, including a current region of blocks comprising a plurality of blocks; (ii) partitioning the plurality of blocks in the current region, including: the current region is a first type of region, allowing partitioning of the plurality of blocks below a predefined threshold and when the current region is a second type of region, disallowing partitioning of the plurality of blocks below the predefined threshold; and (iii) reconstructing the plurality of blocks of the current region. In this way, the supported block sizes or block partition types may depend on the region type for each coded block.

(C2) In some embodiments of C1, the predefined threshold is equal to 4 samples. For example, the minimum block size for the second type of region may be set to 4x4. As another example, partitioning that would decrease a block dimension below 4 may be disallowed for the second type of region. For example, when one partition node is 8xN (or Nx8) in intra region, it may be further split into two blocks. However, when one partition node is 8xN (or Nx8) in the mixed intra and inter region, it can’t be further split into two blocks. In some embodiments, when a partition node is 32x4 (or 4x32) block in intra region, it may be further split to 4 blocks with uneven 4-way block partition. However, when the partition node is 32x4 (or 4x32) in the mixed intra and inter region, uneven 4-way block partition is disallowed.

(C3) In some embodiments of C1 or C2, the second type of region comprises a chroma merge region. For example, partitioning a 4x4 block may be supported in intra region, but not supported in a mixed intra and inter region. As an example, a chroma merge area is implicitly derived as inter region, and all the luma and chroma blocks in this region need to be inter coded.

(C4) In some embodiments of any of C1-C3, the first type of region comprises an intra region and the second type of region comprise a mixed region. For example, the supported block sizes may be different for coded blocks in intra region and mixed intra and inter region. As an example, the minimum supported block size may be different for coded blocks in intra region and mixed intra and inter region.

(C5) In some embodiments of any of C1-C4, a first set of partition types is allowed for the first type of region, and a second set of partition types is allowed for the second type of region. For example, the allowed block partition types may be different for intra region and mixed intra and inter region with certain block sizes.

(C6) In some embodiments of any of C1-C5, the plurality of blocks are required to have a same partitioning mode. For example, luma coded blocks in chroma merge area can be either intra coded block or inter coded block, but chroma blocks are always set to a predefined mode, such as inter prediction mode or intra prediction mode. As an example, if the last luma coded block in chroma merge area is inter coded block, the chroma block in this merge area is derived as intra prediction mode, and the prediction mode is derived as cross component intra prediction mode, such as chroma luma mode or multi-hypothesis cross component prediction. In another example, if the last luma coded block in chroma merge area is intra coded block, the chroma block in this merge area is derived as intra prediction mode, and the exact prediction direction for chroma block may be further signaled.

(C7) In some embodiments of any of C1-C6, the plurality of blocks includes a chroma block and a luma block; and motion information for the chroma block is derived based on motion information for the luma block. For example, the reference frames and/or the motion vector for chroma block may be derived from its co-located luma block or co-located neighboring luma block. In another example, the motion vector for chroma block is set to zero MV if its co-located luma block is intra coded block. In some embodiments, the motion vector for a chroma block is set to the motion vector of its preceding co-located inter-coded luma block in decoding order in chroma merge area.

(C8) In some embodiments of any of C1-C7, when the current region comprises the second type of region, a prediction mode for all blocks within the current region is set to inter prediction. For example, a chroma merge area is implicitly derived as inter region, and all the luma and chroma blocks in this region are required to be inter coded or intra block copy mode. In some embodiments, luma blocks in the chroma merge area are allowed to be either inter coded or intra block copy mode, but chroma blocks in the chroma merge area are required to be inter coded. In some embodiments, luma blocks in the chroma merge area may have different motion vectors to perform motion compensation (MC). But chroma blocks in the chroma merge area use the same motion vector to perform MC. In some embodiments, chroma blocks in the chroma merge area use the motion vector from a luma block with a predefined position. For example, the predefined position can be center position, top-left position, or bottom-right position of current chroma merge area.

(D1) In another aspect, some embodiments include a method of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current region of blocks comprising a plurality of blocks; (ii) partitioning the plurality of blocks in the current region, including: when the current region is a first type of region, allowing partitioning of the plurality of blocks below a predefined threshold; and when the current region is a second type of region, disallowing partitioning of the plurality of blocks below the predefined threshold; and (iii) encoding the plurality of blocks of the current region. In some embodiments, the method further includes signaling the plurality of blocks of the current region in a video bitstream.

(D2) In some embodiments of D1, the predefined threshold is equal to 4 samples.

(D3) In some embodiments of D1 or D2, the second type of region comprises a chroma merge region.

(D4) In some embodiments of any of D1- D3, the first type of region comprises an intra region and the second type of region comprise a mixed region.

(D5) In some embodiments of any of D1-D4, a first set of partition types is allowed for the first type of region, and a second set of partition types is allowed for the second type of region.

(D6) In some embodiments of any of D1-D5, the plurality of blocks are required to have a same partitioning mode.

(D7) In some embodiments of any of D1-D6, when the current region comprises the second type of region, a prediction mode for all blocks within the current region is set to inter prediction.

(E1) In one aspect, some embodiments include a method of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks, including a current region of blocks comprising a plurality of blocks; (ii) when a block of the plurality of blocks has a size that is less than a predefined threshold, setting respective prediction modes of the plurality of blocks as being a same prediction mode; and (iii) reconstructing the current region using the respective prediction modes of the plurality of blocks. In this way, prediction mode of a last luma block in chroma merge area may be derived based on coded information. For example, the prediction mode of the last luma block may be derived as a predefined mode when the block width and height ratio satisfy a predefined condition.

(E2) In some embodiments of E1, the current region comprises a mixed inter-intra region. For example, if the region type of chroma merge region is MIXED_INTER_INTRA, a prediction mode of the first or last luma block may depend on the block size, block width, and/or height ratio of last luma block.

(E3) In some embodiments of E1 or E2, the plurality of blocks comprises one or more luma blocks and one or more chroma blocks. In some embodiments, all luma blocks in the current region are required to have the same prediction mode. For example, the prediction mode of all the luma blocks within a chroma merge region may be required to be the same prediction mode. As an example, the prediction mode of all the coded block for chroma merge region may be required to be inter coded. In some embodiments, an intra block copy mode is regarded as an intra prediction mode. In some embodiments, an intra block copy mode is regarded as an inter prediction mode.

(E4) In some embodiments of any of E1-E3, the block is a chroma block. In some embodiments, the chroma block within the chroma merge region is always set to a predefined mode regardless of the prediction mode of the luma coded block with the chroma merge region. In some embodiments, the predefined mode is a chroma-from-luma (CfL) mode. In some embodiments, the predefined mode is an inter prediction mode. As an example, if the chroma merge region is a MIXED_INTER_INTRA region, the chroma prediction mode is set as inter prediction mode. In some embodiments, chroma inter prediction uses buffered luma MV’s from the first inter block in the MIXED_INTRA_INTER region. As another example, if the chroma merge region is an INTRA region, the chroma prediction mode is set as a CfL intra prediction mode.

(E5) In some embodiments of any of E1-E4, the same prediction mode comprises an inter prediction mode. In some embodiments, the same prediction mode is an intra coded mode, an inter coded mode, or an intra block copy mode.

(E6) In some embodiments of any of E1-E5, the predefined threshold comprises a block dimension being 4 samples or less. For example, when the block size of the last luma block is 4xN or Nx4, the last luma block may be derived to be a predefined mode. As an example, N may be greater than or equal to 16, such as 16, 32, 64. In some embodiments, when the block size of the last luma block is 4xN or Nx4, it is the child node from 4xM or Mx4, and N < M, the last luma block is derived as the predefined mode. As an example, M may be equal to 16 and N may be equal to 8.

(E7) In some embodiments of any of E1-E6, the video bitstream does not include a flag indicating a prediction mode of the plurality of blocks. For example, when the prediction mode of the last luma block is derived as the predefined mode, the flag for indicating whether a coded block is intra coded or inter code is not signaled/parsed in the bitstream. In some embodiments, the prediction mode for the plurality of blocks is derived without being parsed from the bitstream. In some embodiments, a high-level syntax is signaled (e.g., at the sequence, multi-frame, frame, or slice level) to indicate whether the last luma block in chroma merge area can be derived to be a predefined mode or not. In some embodiments, the predefined mode is signaled at the sequence level, multi-frame, frame level, or slice level.

(E8) In some embodiments of any of E1-E7, a prediction mode for a last luma block of the current region is derived based on a size of the last luma block. For example, the prediction mode of the last luma block in one chroma merge region is derived to be intra coded when the block size is 4x4.

(F1) In another aspect, some embodiments include a method of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current region of blocks comprising a plurality of blocks; (ii) when a block of the plurality of blocks has a size that is less than a predefined threshold, setting respective prediction modes of the plurality of blocks as being a same prediction mode; and (iii) encoding the current region using the respective prediction modes of the plurality of blocks.

(F2) In some embodiments of F1, the current region comprises a mixed inter-intra region. The mixed inter-intra region may be defined as a region where at least one block is inter coded and at least one block is intra coded, allowing for flexible prediction mode assignment within the region. The mixed region may be established based on the presence of certain partition types or coding constraints, such as when a parent partition node produces both intra and inter coded child blocks. The mixed inter-intra region may be signaled explicitly in the bitstream or derived implicitly based on block-level coding decisions.

(F3) In some embodiments of F1 or F2, the plurality of blocks comprises one or more luma blocks and one or more chroma blocks. The plurality of blocks may include multiple luma blocks and multiple chroma blocks, with each chroma block potentially referencing more than one luma block (as in a chroma merge region). The region may consist of a single luma block and a single chroma block, or a combination of various block sizes and types, depending on the partitioning structure. The relationship between luma and chroma blocks may be defined by the coding standard or by specific signaling in the bitstream, such as through merge flags or region type indicators.

(F4) In some embodiments of any of F1- F3, the block is a chroma block. The block may be a chroma block that is co-located with one or more luma blocks, and its prediction mode may be determined based on the prediction modes of the associated luma blocks. The block may be a chroma block within a chroma merge region, where the prediction mode is set according to the rules for that region (e.g., always inter prediction when the chroma block is smaller than a threshold). The chroma block may be subject to additional constraints, such as being restricted to certain prediction modes or being excluded from further partitioning.

(F5) In some embodiments of any of F1-F4, the same prediction mode comprises an inter prediction mode. The inter prediction mode may include single motion vector prediction, compound prediction, or advanced inter prediction techniques such as warped motion or affine motion compensation. The inter prediction mode may be selected from a set of allowed modes based on region type, block size, or other coding parameters. The inter prediction mode may be applied uniformly to all blocks in the region, or selectively based on additional criteria such as coding efficiency or hardware constraints.

(F6) In some embodiments of any of F1-F5, the same prediction mode is not signaled in a video bitstream. The absence of explicit signaling for the prediction mode in the video bitstream may be achieved by deriving the prediction mode based on predefined rules, such as block size, region type, or partitioning structure. Alternatively, a high-level syntax element may be signaled at the sequence, frame, or slice level to indicate that certain regions or blocks use a fixed prediction mode, thereby eliminating the need for block-level signaling. The decoder may infer the prediction mode based on context or by referencing neighboring blocks, reducing the overhead in the bitstream and simplifying the decoding process.

(G1) In one aspect, some embodiments include a method of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks, including a current region of blocks comprising a luma block and a co-located chroma block; (ii) deriving a prediction mode for the luma block based on a region type of the current region; (iii) deriving a prediction mode for the co-located chroma block based on prediction mode for the luma block and (iv) reconstructing the current region using the derived prediction mode for the luma block and the derived prediction mode for the co-located chroma block. In this way, the prediction mode of the first or last luma block in a chroma merge area may be derived from the coded information, and the chroma block inherits the coding mode information from the luma block that carries chroma information. In some embodiments, the prediction mode for the luma block is not signaled in the video bitstream. In some embodiments, the prediction mode for the chroma block is not signaled in the video bitstream. In some embodiments, the current region corresponds to a superblock or largest coding unit. In some embodiments, the current region corresponds to a multiple chroma blocks and/or luma blocks.

(G2) In some embodiments of G1, deriving the prediction mode for the luma block comprises: when the current region is an intra region, deriving the prediction mode for the luma block as an intra prediction mode; and when the current region is a mixed region, deriving the prediction mode of the luma block as an inter prediction mode. For example, the prediction mode of the first or last luma block may depend on the region type of current region/coded block. The process of deriving the prediction mode for the luma block may further consider additional factors such as the partition type or block size within the current region. For example, if the region is a mixed intra and inter region but contains only large blocks, the prediction mode may still be set to inter prediction for hardware simplicity. Alternatively, the prediction mode may be determined by a high-level syntax element signaled at the sequence, frame, or slice level, which globally enforces intra or inter prediction for certain regions. The derivation may also account for the coding history or context of neighboring regions, allowing for adaptive switching between intra and inter prediction modes based on local statistics or prior coding decisions.

(G3) In some embodiments of G2, the intra prediction mode is one of: a directional intra prediction mode, a non-directional intra prediction mode, and an intra block copy mode. The intra prediction mode may further include specific directional modes such as vertical, horizontal, planar, or diagonal prediction, as well as DC prediction. The non-directional intra prediction mode may encompass modes like planar or DC, which do not rely on a specific spatial direction. The intra block copy mode may be implemented as a special case of intra prediction where a block is predicted by copying pixel values from another location within the same frame, potentially with an offset or transformation. Additional intra prediction modes such as palette-based prediction or linear prediction with matched reference templates may also be supported, depending on the codec design.

(G4) In some embodiments of any of G1-G3, when the current region is an intra region, all luma blocks within the current region are intra coded. When the current region is an intra region, not only are all luma blocks intra coded, but the chroma blocks within the region may also be restricted to intra prediction modes, such as CfL or DC prediction. The intra region may allow for further partitioning of luma blocks into smaller intra coded sub-blocks, while chroma blocks may be restricted from further partitioning to simplify hardware implementation. The intra region may be defined by a high-level syntax element, and the enforcement of intra coding for all luma blocks may be verified during bitstream parsing or decoding.

(G5) In some embodiments of any of G1-G4, the luma block is a last luma block in the current region. In some embodiments, the luma block is the first luma block in the current region. In some embodiments, the luma block used for prediction mode derivation is selected based on a predefined order, such as raster scan, zigzag, or coding tree traversal. The choice between the first or last luma block may depend on the desired hardware architecture or the need to minimize decoding latency. For example, referencing the first luma block may enable earlier decision-making in the decoding pipeline, while referencing the last luma block may be advantageous when processing is performed in a sequential or block-wise manner. The luma block may be selected based on its spatial location (e.g., top-left, center, or bottom-right) or based on specific coding criteria, such as block size, partition type, or the presence of certain prediction modes in neighboring blocks.

(G6) In some embodiments of G5, the prediction mode for the luma block is based on a prediction mode of a first luma block in the current region. For example, the prediction mode of the last luma block may depend on the prediction mode of the first luma block. As an example, if the prediction mode of the first luma block is intra coded, then the last luma block is intra coded. In some embodiments, the prediction mode of the last luma block depends on the prediction mode of the first luma block and the block size of the first luma block. For example, if the block size of the first luma is 4xN or Nx4 (where N = 4, 8, 16, 32, 64), then the last luma is predicted using same prediction mode as the first luma. In this example, if the first luma block is inter coded, then the last luma block is inter coded. As another example, if the block size of the first luma is 4xN or Nx4 (where N = 4, 8, 16, 32, 64), then the last luma is predicted using opposite prediction mode as the first luma. In this example, if the first luma block is inter coded, then the last luma block is intra coded. As another example, if the block size of the first luma is not 4xN or Nx4 (where N = 4, 8, 16, 32, 64), then the last luma is predicted using same prediction mode as the first luma. In this example, if the first luma block is inter coded, then the last luma block is inter coded. As another example, if the block size of the first luma is not 4xN or Nx4 (where N = 4, 8, 16, 32, 64), then last luma is predicted using opposite prediction mode as the first luma. In this example, if the first luma block is inter coded, then the last luma block is intra coded.

(G7) In some embodiments of any of G1-G6, when the current region is a mixed region, the prediction mode of the luma block is further based on a partition type for the luma block. For example, if the region type is MIXED_INTER_INTRA, prediction mode of the first or last luma block may depend on the partition type of luma. As an example, if the partition type is PARTITION_VERT_4A, PARTITION_HORZ_4A, PARTITION_VERT_4B, PARTITION_HORZ_4B, last luma is intra coded.

(G8) In some embodiments of any of G1-G7, the prediction mode for the luma block is not signaled in the video bitstream. For example, the prediction mode of the last luma block can be implicitly derived.

(G9) In some embodiments of any of G1-G8, the prediction mode of the luma block is further based on a block size of the luma block. For example, prediction mode of the first or last luma block may depend on block size of the first or last luma. As an example, if the block size of the last luma is 4xN or Nx4 (where N = 4, 8, etc.), last luma is intra coded. In some embodiments, the prediction mode of the luma block is further based on a block size of the luma block and a partition type for the luma block. For example, if the partition type is PARTITION_VERT_4A, PARTITION_HORZ_4A, PARTITION_VERT_4B, PARTITION_HORZ_4B and the block size of the last luma is 4XN or NX4 (where N = 4, 8, 16, 32, 64), last luma is intra coded.

(G10) In some embodiments of any of G1-G9, the prediction mode for the co-located chroma block is inherited from the luma block. For example, the chroma block may inherit prediction mode information from the first luma block. As another example, the chroma block inheriting prediction mode information from the first luma block may depend on the prediction mode of last luma block. For example, when the prediction mode of the last luma block is implicitly derived and is the same as the first luma block, then chroma inherits prediction mode information from the first luma block.

(G11) In some embodiments of any of G1-G10, the current region is a chroma merge region. In some embodiments, allowing chroma merge depends on the block size of the chroma block. For example, chroma merge is allowed if the width and the height of the chroma block is less than or equal to a threshold T, e.g., where T is set to 4, 8, 12, etc. In some embodiments, allowing chroma merge depends on the partition type of the luma block. For example, chroma merge may be disallowed if the partition type is PARTITION_SPLIT.

(H1) In another aspect, some embodiments include a method of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current region of blocks comprising a luma block and a co-located chroma block; (ii) deriving a prediction mode for the luma block based on a region type of the current region; (iii) deriving a prediction mode for the co-located chroma block based on prediction mode for the luma block and (iv) encoding the current region using the derived prediction mode for the luma block and the derived prediction mode for the co-located chroma block. In some embodiments, the prediction mode for the luma block is not signaled in a video bitstream. In some embodiments, the prediction mode for the chroma block is not signaled in the video bitstream.

(H2) In some embodiments of H1, deriving the prediction mode for the luma block comprises: when the current region is an intra region, deriving the prediction mode for the luma block as an intra prediction mode; and when the current region is a mixed region, deriving the prediction mode of the luma block as an inter prediction mode.

(H3) In some embodiments of H1 or H2, the luma block is a last luma block in the current region. The luma block may be the first luma block in the current region, or any luma block designated by a particular position or order within the region, such as a center or top-left luma block. The determination of which luma block is referenced may depend on the partitioning scheme or the signaling in the bitstream. For example, the prediction mode of the last luma block may be used when the region is processed in raster scan order, while in other cases, the first luma block may be referenced if the coding order or hardware architecture favors early decision-making. Additionally, the luma block referenced for prediction mode derivation may be selected based on block size, partition type, or other region-specific criteria.

(H4) In some embodiments of any of H1- H3, the prediction mode for the co-located chroma block is inherited from the luma block. In some embodiments, the inheritance of the prediction mode for the co-located chroma block from the luma block is conditional. For example, the chroma block may inherit the prediction mode only if the luma block is inter coded, or only if the luma block’s prediction mode is implicitly derived rather than explicitly signaled. As an example, the chroma block may inherit additional parameters from the luma block, such as motion vectors or reference frame indices, or may use a modified version of the luma block’s prediction mode (e.g., applying a CfL mode if the luma block is intra coded). The chroma block may inherit the prediction mode from a group of luma blocks, such as by majority voting or by referencing a predefined luma block position within the region.

(H5) In some embodiments of any of H1-H4, the current region is a chroma merge region. In some embodiments, the chroma merge region is defined not only by the presence of small chroma blocks (e.g., width or height less than or equal to 4 samples), but also by specific partition types or coding constraints. For example, a chroma merge region may be established when a parent partition node produces multiple luma blocks that are referenced by a single chroma block, or when the partitioning structure results in non-square or unevenly sized blocks. The chroma merge region may also be implicitly derived based on high-level syntax element(s). The chroma merge region may be restricted to certain region types, such as mixed intra and inter regions, or may be disallowed in pure intra regions. The chroma merge region may further depend on the minimum supported block size, the allowed partition types, or the presence of specific coding features such as intra block copy or inter-intra prediction modes.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A10, B1-B6, C1-C8, D1-D7, E1-E8, F1-F6, G1-G11, and H1-H5 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A10, B1-B6, C1-C8, D1-D7, E1-E8, F1-F6, G1-G11, and H1-H5 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

Although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current region of blocks comprising one or more chroma blocks;
when the current region is a first type of region, assigning a same prediction mode to the one or more chroma blocks; and
reconstructing each chroma block of the one or more chroma blocks by applying the prediction mode at a sub-block level.

2. The method of claim 1, wherein applying the prediction mode at the sub-block level comprises performing motion compensation at the sub-block level.

3. The method of claim 1, wherein the first type of region is a chroma merge region.

4. The method of claim 1, wherein the first type of region is a mixed inter-intra region.

5. The method of claim 1, wherein motion information for the one or more chroma blocks is derived from one or more co-located luma blocks.

6. The method of claim 5, wherein the motion information for the one or more chroma blocks in inherited from one or more luma blocks of the current region.

7. The method of claim 1, further comprising determining a number of sub-blocks for the one or more chroma blocks based on a number of luma blocks in the current region.

8. The method of claim 1, wherein:
a first set of block sizes are permitted for the first type of region; and
a second set of block sizes are permitted for a second type of region, the second set being different than the first set.

9. The method of claim 8, wherein the first type of region has a different minimum block size than the second type of region.

10. The method of claim 1, wherein the one or more chroma blocks comprises a plurality of chroma blocks and each chroma block of the plurality of chroma blocks uses a same motion vector to perform motion compensation.

11. A method of video encoding performed at a computing system having memory and one or more processors, the method comprising:
receiving video data comprising a plurality of blocks, including a current region of blocks comprising one or more chroma blocks;
when the current region is a first type of region, assigning a same prediction mode to the one or more chroma blocks; and
encoding each chroma block of the one or more chroma blocks by applying the prediction mode at a sub-block level.

12. The method of claim 11, wherein applying the prediction mode at the sub-block level comprises performing motion compensation at the sub-block level.

13. The method of claim 11, wherein the first type of region is a chroma merge region.

14. The method of claim 11, wherein the first type of region is a mixed inter-intra region.

15. The method of claim 11, wherein motion information for the one or more chroma blocks is derived from one or more co-located luma blocks.

16. The method of claim 11, further comprising determining a number of sub-blocks for the one or more chroma blocks based on a number of luma blocks in the current region.

17. A non-transitory computer-readable storage medium storing a video bitstream that is generated by a video encoding method, the video bitstream comprising:
coded information for a plurality of encoded blocks including a current region comprising one or more chroma blocks, wherein the coded information is based on applying a same prediction mode to the one or more chroma blocks at a sub-block level; and
wherein the video encoding method comprises:
in accordance with the current region being a first type of region, assigning the same prediction mode to the one or more chroma blocks; and
encoding each chroma block of the one or more chroma blocks by applying the prediction mode at the sub-block level.

18. The non-transitory computer-readable storage medium of claim 17, wherein applying the prediction mode at the sub-block level comprises performing motion compensation at the sub-block level.

19. The non-transitory computer-readable storage medium of claim 17, wherein the first type of region is a chroma merge region.

20. The non-transitory computer-readable storage medium of claim 17, wherein motion information for the one or more chroma blocks is derived from one or more co-located luma blocks.
